(19) United States
(12) Patent Application Publication
(10) Pub. No.: US 2004/0192225 A1
(43) Pub. Date: Sep. 30, 2004

(54) Method of branding the speaker of a wireless device

(76) Inventor: Roger C. Mahn, Canton, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/235,001

(22) Filed: Sep. 4, 2002

(51) Int. Cl. H04B 1/38

(52) U.S. Cl. 455/90.1; 455/575.1

(57) ABSTRACT

A method of branding a wireless device is provided. The method comprises providing a logo in a design of a speaker area of a first wall of a wireless device. The logo is provided in the speaker area by at least one of one or more openings defined in the first wall through which sound travels from a speaker provided within the housing of the device; one or more false holes provided on the first wall; or stenciling, embossing, coloring, painting, texturing, indenting, or applying a sticker to the first wall. In the alternative, the logo may be provided by a combination of any of the foregoing.

### FIELD OF THE INVENTION

The present invention relates to a method of branding a wireless device and, more particularly, to providing a logo as part of a design in a speaker area of the wireless device.

### BACKGROUND OF THE INVENTION

Wireless devices include cellular phones, pagers, personal digital assistants (PDAs), and the like. Generally, a wireless device is manufactured by one entity that sells these devices to a wireless carrier. The wireless carriers provide the equipment, such as satellites and cell towers, which enable users of the wireless devices to send and receive wireless communications from the wireless devices. It should be appreciated that there are numerous wireless device manufacturers, including KYOCERA, MOTOROLA, NOKIA, SAMSUNG, SANYO, and SONY ERICSSON, as well as numerous wireless carriers, including CINGULAR WIRELESS (“CINGULAR”), ALLTEL, AT&T WIRELESS, SPRINT PCS, VERIZON WIRELESS, and VOICESTREAM WIRELESS. The wireless carrier in turn sells the wireless devices to end users such as individuals or companies whose employees use the wireless devices for wireless communications.

As with any other product, companies desire to place their company name, trademark, or logo onto the product in a manner such that the user of the product, and anyone else who views the product, sees their name, trademark, or logo, and recognizes the product as made, sold, and/or distributed by that company. Branding a product is thus a highly valuable tool to get consumers to recognize one's products and hopefully to buy and/or use one's products in the future.

The wireless device manufacturer typically places a plurality of logos on the devices, both of the manufacturer and of the wireless carrier. Traditionally, with respect to visibility of a company logo to the end user, as well as the general public, the wireless device manufacturer has primary branding placement and the wireless carrier has secondary branding placement. The manufacturer's logos typically include the company logo for that manufacturer and the logo for the specific brand of the device. The wireless carrier's logo typically includes the company logo for that wireless carrier.

The logos are typically stenciled, embossed, or silk screened into a housing of the wireless device or, in the alternative, are placed on stickers that are adhered to the housing.

Often, the wireless device manufacturer places the company logo of the wireless carrier at or near the bottom of the wireless device. FIG. 8 illustrates one currently available wireless device, the NOKIA 5165 cellular telephone. This type of wireless device is manufactured by NOKIA, who sells the devices to CINGULAR, the assignee of the present invention. CINGULAR then sells the devices to end users. As shown in FIG. 8, NOKIA provides its own logo just above a screen area of the wireless device and CINGULAR's logo on the bottom of the wireless device, below the keypads.

As shown in FIG. 9, in another currently available wireless device, the SONY ERICSSON T68 cellular telephone, the logo or name of the wireless device manufacturer is positioned just below the speaker area. The logo or name is not, however, part of a design of the speaker area of the device.

As wireless devices become smaller, it can become difficult to brand these devices with logos. More particularly, as these devices become smaller, the screen area and/or the keypad area of the device takes up more space over the front of the device, which leaves less space for the placement of logos on the front of the device. As a result, the stickers with the logos thereon have become smaller, the company logos on these stickers have become smaller, and/or the company logos stenciled on the wireless device have become smaller. This results in a diminished impact of the company logo on the end user, as well as on the general public.

Also, on many wireless devices, the wireless device manufacturer places its own name or logo onto the back of the device, such as by stenciling, often on the battery cover of the device. While a user would see the logo or name of the company if he/she viewed the back of the device, users more often view the front of the device when in use.

The present invention solves these needs and others, by providing a method of branding a logo as part of a design in a speaker area of the wireless device, an area often looked to by users of the wireless device.

### SUMMARY OF THE INVENTION

The present invention provides a method of branding a wireless device. The wireless device includes a housing having at least a first wall. The first wall includes a speaker area. The method comprises the step of providing a logo in a design of the speaker area.

The present invention also provides a wireless device comprising a housing having at least a first wall. The first wall includes a speaker area. A logo is provided in a design of the speaker area.

In one embodiment, the logo is provided in the speaker area by at least one of one or more openings defined in the first wall through which sound travels from a speaker provided within the housing of the device; one or more false holes provided on the first wall; or stenciling, embossing, coloring, painting, texturing, indenting, or applying a sticker to the first wall. In another embodiment, the logo is provided in the speaker area by a plurality of one or more openings defined in the first wall through which sound travels from a speaker provided within the housing of the device; one or more false holes provided on the first wall; stenciling, embossing, coloring, painting, texturing, indenting, or applying a sticker to the first wall; or a combination of any of the foregoing.

In one embodiment, the logo is at least one of a wireless carrier or a manufacturer of the wireless device. In one embodiment, the logo is at least one of a company name, logo, or trademark.

In one embodiment, the speaker area is provided for a speaker that provides voice conversations. In another embodiment, the speaker area is provided for a speaker that provides tones.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a front plan view of one embodiment of a wireless device branded with a logo in a design of a speaker area of the device;

FIG. 2 is an exploded view of the speaker area shown in FIG. 1;

FIG. 3 is a front plan view of another embodiment of a wireless device branded with a logo in a design of a speaker area of the device;

FIG. 4 is an exploded view of the speaker area shown in FIG. 3;

FIG. 5 is a front plan view of another embodiment of a wireless device branded with a logo in a design of a speaker area of the device;

FIG. 6 is an exploded view of the speaker area shown in FIG. 5;

FIG. 7 is an example of a logo, the logo being that of the Assignee of the present invention;

FIG. 8 is a front plan view of a prior art wireless device; and

FIG. 9 is a front plan view of another prior art wireless device.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

The present invention provides a method of branding a logo, company name, or trademark as part of a design of a speaker area of a wireless device. There are generally two types of speakers in wireless devices. One type is a speaker from which the user hears a voice conversation. For this type, the user generally places his/her ear next to an opening positioned on the outside of the wireless device from which sound from the speaker inside the device travels through to outside of the device. The other type is a speaker where a tone is sounded by the device to indicate certain occurrences. These tones include, for example, ring tones for indicating an incoming telephone call or alert tones for indicating a voice mail message or a text message. Also, if the wireless device includes a game, this speaker can sound tones for the game. The present invention may be part of a design of a speaker area for one or both of these types of speakers.

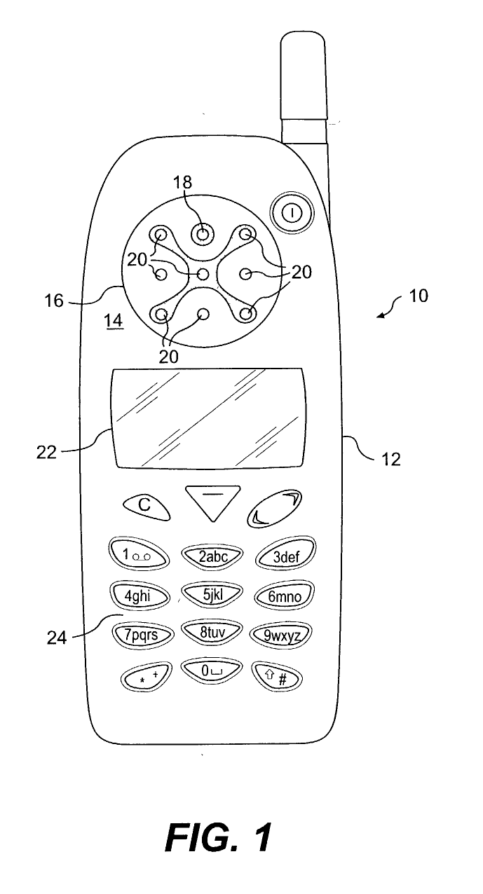

As shown in FIGS. 1, 3, and 5, the wireless device 10 includes a housing 12 with at least a first wall 14. The first wall 14 typically includes a speaker area 16, a screen area 22, and a keypad area 24. As shown, the first wall 14 may be considered to be the “front” wall because it is the wall visible to the user when in use.

The speaker area 16 is generally proximal to the top of the device 10. A microphone (not shown) is generally positioned proximal to the bottom of the device. With the speaker area 16 proximal to the top and the microphone proximal to the bottom, the user may place the speaker area near his/her ear and the microphone near his/her mouth at the same time. While as shown the speaker area 16 is circular, it should be appreciated the speaker area 16 may comprise of variety of shapes, including, but not limited to, square, rectangular, or triangular.

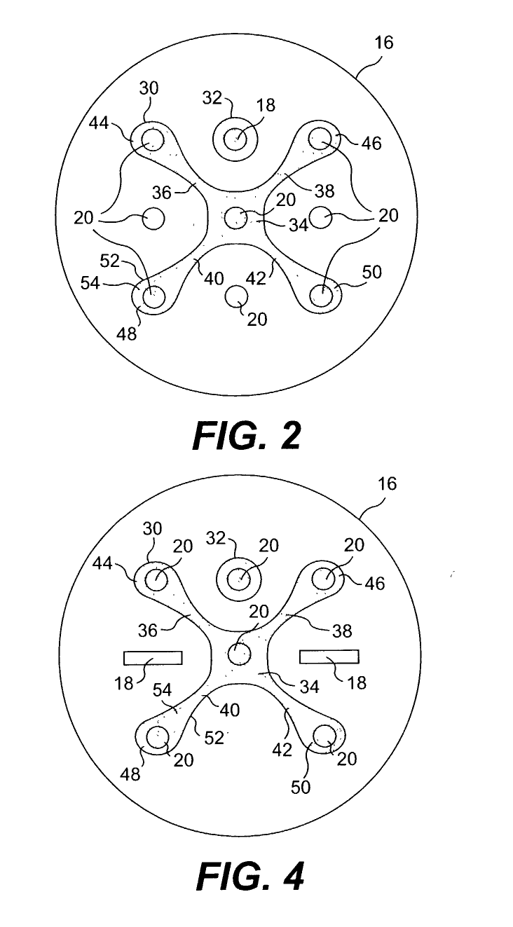

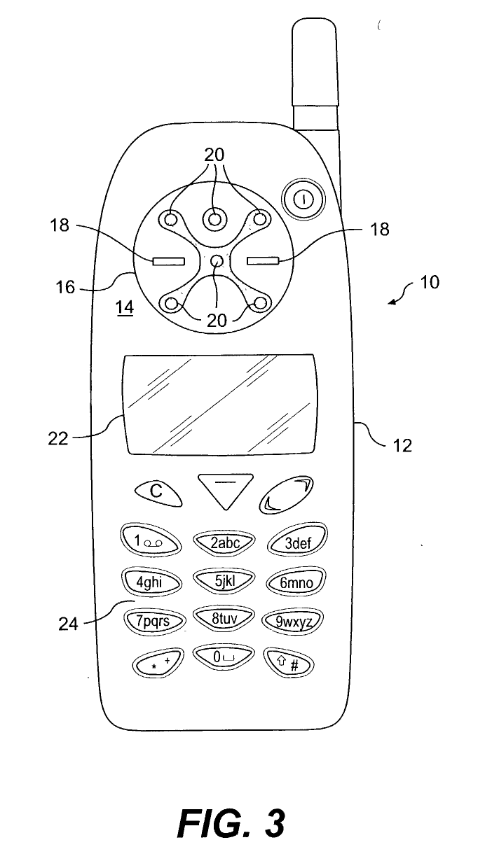

In the speaker area, the wireless device typically includes one or more openings through which sound travels from one or more speakers inside the wireless device through the opening(s) to the outside. It should be appreciated that the housing 12 defines an interior compartment. It should also be appreciated that various components of the wireless device 10 are provided within the interior compartment, including, for example, at least one speaker. As shown in FIGS. 1-6, in the speaker area 16, the front wall 14 defines at least one opening 18. The opening 18 is provided to allow sound to travel from the speaker contained within the interior compartment out through the opening 18 to outside of the housing 12. The number of openings for sound to travel from speaker(s) inside the interior compartment is not limited to a single opening. As shown in FIGS. 3 and 4, the front wall 14 may define a plurality of openings 18 for sound to travel from the speaker to outside of the housing 12. It should also be appreciated that each opening 18 may comprise a variety of sizes and shapes, including, but not limited to, circular (see FIGS. 1 and 2), rectangular (see FIGS. 3-6), square, oval, or tear drop.

Often, the wireless device 10 includes one or more “false holes” 20 in the speaker area 16. These false holes 20 look like openings through which sound may travel from within the housing 12 to outside of the housing 12. Generally, these false holes 20 give the impression to the user that the speaker area 16 is a large area with many openings through which sound may travel. In fact, sound only travels through the one or more openings 18. The false holes 20 may be provided on the housing 12 of the wireless device 10 by a variety of manners, including, but not limited to, stenciling, embossing, silk screening, coloring, painting, texturing, indenting, or applying a sticker to the wireless device housing 12. Similar as with the openings 18, it should be appreciated that each false hole 20 may comprise a variety of sizes and shapes, including, but not limited to, circular (see FIGS. 1-6), rectangular, square, oval, or tear drop.

The screen area 22 is provided to show graphics, numbers, letters, and the like. For example, if the user wants to call someone at a particular telephone number, he/she would press the desired numbers in the keypad area 24 and the numbers pressed would appear on the screen area 22. In addition, if the user wants to play a game on the device, graphics for the game would appear on the screen area 22. Again, while as shown the screen area 22 is generally square in shape, it should be appreciated that the screen area 22 may comprise a variety of shapes, including, but not limited to, circular, rectangular, or triangular.

For a cellular telephone, the keypad area 24 includes a plurality of keypads, typically for the numbers one through nine, the # sign, and the * sign, in four rows and three columns, similar to most, if not all, non-rotary telephones. In addition, other keypads may be provided on the housing 10, such as a clear keypad (often labeled “c” on cellular telephones) and an up and down keypad (often labeled with up and down arrows.) Each keypad may comprise a variety of shapes and sizes. Examples of shapes include, but are not limited to, oval, square, or circular.

As stated above, the present invention provides a method of branding a logo, company name, or trademark as part of a design of the speaker area of the wireless device. The speaker area is often the focal point of the end user's view. More particularly, when there is an incoming telephone call and the wireless device rings a ring tone, the user typically looks to the speaker area in order to know where to place his/her ear next to the device to be able to hear the voice conversation that will ensue. Thus, placing the logo, company name, or trademark where the end user often looks provides increased brand impact on at least the end user, as well as the general public.

The logo, company name, or trademark may be provided in the speaker area in any manner which distinguishes the logo, company name, or trademark from the remainder of the speaker area. More particularly, the logo, company name, or trademark may be provided by, for example, one or more openings through which sound travels from a speaker provided within the interior the device, one or more false holes, stenciling, embossing, silk screening, coloring, painting, texturing, indenting, applying a sticker, or a combination of any of the foregoing.

In one embodiment, the false holes 20 are used as a guide for the logo, so that one can provide a logo in the design of a speaker area 16 of a wireless device 10 without compromising the quality of the sound outputted from the openings 18 through which sound travels from the speaker within the housing 12.

The term “stenciling” includes, for example, a printing process of printing with a sheet, often made of plastic, in which lettering or a design has been cut so that ink or paint applied to the sheet will reproduce the pattern on a surface beneath the sheet. The term “embossing” includes, for example, a molding or carving process in which a raised design or a design in relief is molded or carved into a surface. The term “silk screening” includes, for example, a printing process of printing with a screen of silk or other fine mesh in which lettering or a design has been imposed thereon and on which an impermeable substance is coated on blank areas, wherein ink or paint is forced through the mesh onto a surface to be printed. The term “coloring” includes, for example, imparting a color to or changing the color of a surface. The term “painting” includes, for example, covering a surface with paint. The term “texturing” includes, for example, giving a desired texture, such as rough or grainy, to a surface. The term “indenting” includes, for example, impressing lettering or a design into a surface.

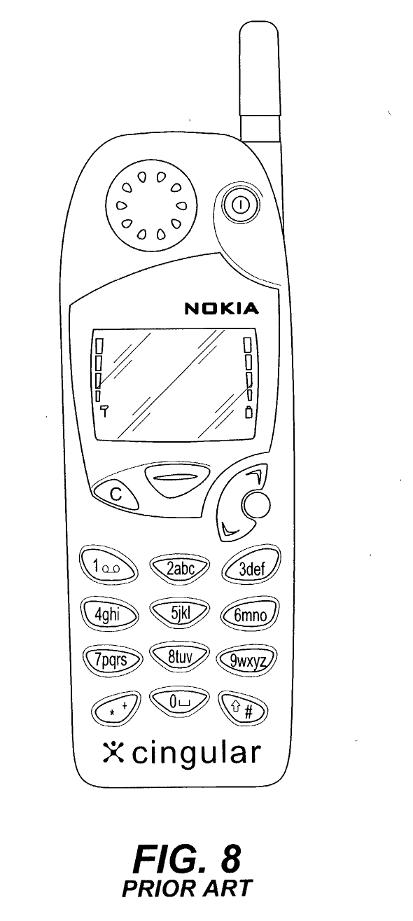

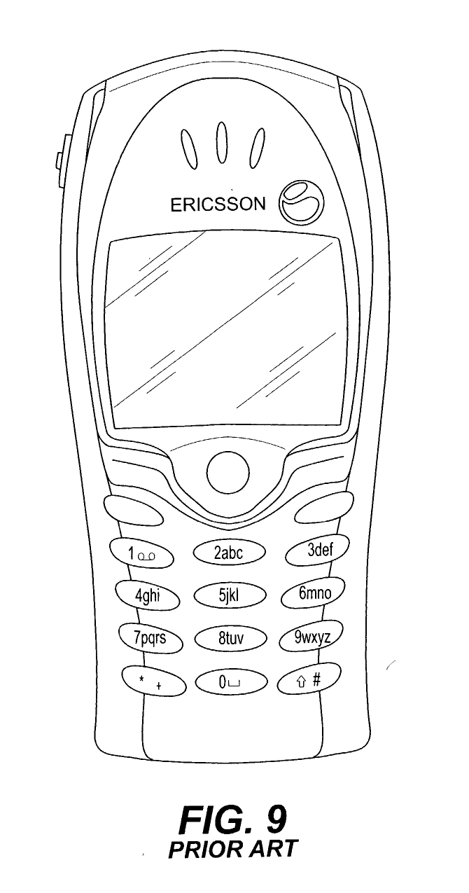

An example of a logo for a wireless device manufacturer or a wireless carrier is that of CINGULAR, the Assignee of the present invention. As shown in FIG. 7, CINGULAR has a logo 30 that resembles a person shaped like a toy jack with a round ball for a head. This logo 30 includes a head portion 32 and a trunk body portion 34 with arm portions 36, 38 and leg portions 40, 42.

The head portion 32 generally has a circular shape and is separate from the body portion 34. The body portion 34 generally has a square shape, with integral outstretched arm portions 36, 38 and leg portions 40, 42. The arm portions 36, 38 have hand portions 44, 46, respectively. Similarly, the leg portions 40, 42 have foot portions 48, 50, respectively. The logo 30 has an outline 52. The logo 30 also has an area 54, being all that area inside the circle of the head portion 42 and within the integral body portion 34. The area 54 is shown shaded in the FIGS. 1-7. It should be appreciated that the shaded areas in FIGS. 1-7 may depict areas of the wall 14 that are stenciled, embossed, silk, screened, colored, painted, indented, textured, or have a sticker applied thereto. If colored or painted, for the logo 30 of the Assignee, this color is a shade of orange. Examples of the method of branding a wireless device will now be discussed, utilizing the logo 30 shown in FIG. 7.

In one embodiment, as shown in FIGS. 1 and 2, the logo 30 for the speaker area 16 is provided by a single opening 18 and a plurality of false holes 20 positioned proximal to single opening 18, and may also include stenciling, embossing, silk screening, coloring, painting, indenting, texturing, applying a sticker, or a combination of any of the foregoing.

In one embodiment (not shown), the single opening 18 provides the head portion 32 of the logo 30. In another embodiment, as shown in FIGS. 1 and 2, the single opening 18 is generally a guide for the head portion 32 of the logo 30. Then, for a larger head portion 32 than just the opening 18 an area of the wall 14 around the opening 18 is stenciled, embossed, silk screened, colored, painted, textured, indented, a sticker applied thereto, or a combination thereof. In another alternative embodiment, the wall 14 may be stenciled, embossed, silk screened, colored, painted, textured, indented, a sticker applied thereto, or a combination thereof around the opening 18 to form the outline of the head portion 32. For this embodiment, all of the area defined by the outline of the head portion 32 around the opening 18 may be stenciled, embossed, silk screened, colored, painted, textured, indented, a sticker applied thereto, or a combination thereof to complete the head portion 32.

In one embodiment (not shown), a plurality of false holes 20 generally provide the body portion 34, the hand portions 44, 46, and/or the foot portions 48, 50 of the logo 30. In another embodiment, as shown in FIGS. 1 and 2, a plurality of false holes 20 generally provide guides for the body portion 34, the hand portions 44, 46, and/or the foot portions 48, 50. It should be appreciated that additional false holes 20 may be positioned in the speaker area 16, as shown in FIGS. 1 and 2, that are not utilized to provide part of the logo or that are not guides for the logo.

Using the false holes 20 as guides, an area around the false holes 20 is stenciled, embossed, silk screened, colored, painted, textured, indented, a sticker applied thereto, or a combination thereof to form the portions of the area 54 of the body portion 34, the arm portions 36, 38, the leg portions 40, 42, the hand portions 44, 46, and the foot portions 48, 50 that are not part of any false hole 20. As shown in FIGS. 1 and 2, in one embodiment, the areas defined by the false holes 20 are also stenciled, embossed, silk screened colored, painted, textured, indented, a sticker applied thereto, or a combination thereof. If colored or painted, in an exemplary embodiment, the area 54 not part of any false hole 20 is colored or painted with generally the same color used to color the areas defined by the false holes 20.

In one embodiment, the outline 52 of the body portion 34, the arm portions 36, 38, the leg portions 40, 42, the hand portions 44, 46, and the foot portions 48, 50 of the logo 30 may be provided by stenciling, embossing, silk screening, coloring, painting, texturing, indenting, applying a sticker thereto, or a combination thereof the wall 14 of the housing 12 around the false holes 20. The area 54 defined by the outline 52 may be stenciled, embossed, silk screened, colored, painted, textured, indented, a sticker applied thereto, or a combination thereof.

As shown in FIGS. 3 and 4, in another embodiment, the wireless device 10 is provided with two openings 18, and the logo 30 for the speaker area 16 is provided by a plurality of false holes 20 positioned proximal to the two openings 18, and may also include stenciling, embossing, silk screening, coloring, painting, indenting, texturing, applying a sticker, or a combination of any of the foregoing.

In one embodiment (not shown), at least one of the false holes 20 provides the head portion 32 of the logo 30. In another embodiment, as shown in FIGS. 3 and 4, at least one false hole 20 is generally a guide for the head portion 32 of the logo 30. Then, for a larger head portion 32 than just the false hole 20, an area of the wall 14 around the false hole 20 is stenciled, embossed, silk screened, colored, painted, textured, indented, a sticker applied thereto, or a combination thereof. In another alternative embodiment, the wall 14 may be stenciled, embossed, silk screened, colored, painted, textured, indented, a sticker applied thereto, or a combination thereof around the false hole 20 to form the outline of the head portion 32. For this embodiment, all of the area defined by the outline of the head portion 32 around the false hole 20 may be stenciled, embossed, silk screened, colored, painted, textured, indented, a sticker applied thereto, or a combination thereof to complete the head portion 32.

As shown most clearly in FIG. 4, one opening 18 is generally positioned between arm portion 36 and leg portion 40 of the logo 30, and another opening 18 is generally positioned between arm portion 38 and leg portion 42 of the logo 30. It should be appreciated that while openings 18 are shown as rectangular in shape in FIGS. 3 and 4, openings 18 may comprise a variety of shapes, such as circular, oval, tear drop, square, and the like.

In one embodiment (not shown), a plurality of false holes 20 generally provide the body portion 34, the hand portions 44, 46, and the foot portions 48, 50 of the logo 30. In another embodiment, as shown in FIGS. 3 and 4, a plurality of false holes 20 generally provide guides for the body portion 34, the hand portions 44, 46, and the foot portions 48, 50.

Using the false holes 20 as guides, an area around the false holes 20 is stenciled, embossed, silk screened, colored, painted, textured, indented, a sticker applied thereto, or a combination thereof to form the portions of the area 54 of the body portion 34, the arm portions 36, 38, the leg portions 40, 42, the hand portions 44, 46, and the foot portions 48, 50 that are not part of any false hole 20. As shown in FIGS. 3 and 4, in one embodiment, the areas defined by the false holes 20 are also stenciled, embossed, silk screened, colored, painted, textured, indented, a sticker applied thereto, or a combination thereof. If colored or painted, in an exemplary embodiment, the area 54 not part of any false hole 20 is colored or painted with generally the same color used to color the areas defined by the false holes 20.

In one embodiment, the outline 52 of the body portion 34, the arm portions 36, 38, the leg portions 40, 42, the hand portions 44, 46, and the foot portions 48, 50 of the logo 30 may be provided by stenciling, embossing, silk screening, coloring, painting, texturing, indenting, applying a sticker thereto, or a combination thereof the wall 14 of the housing 12 around the false holes 20. The area 54 defined by the outline 34 may be stenciled, embossed, silk screened, colored, painted, textured, indented, a sticker applied thereto, or a combination thereof.

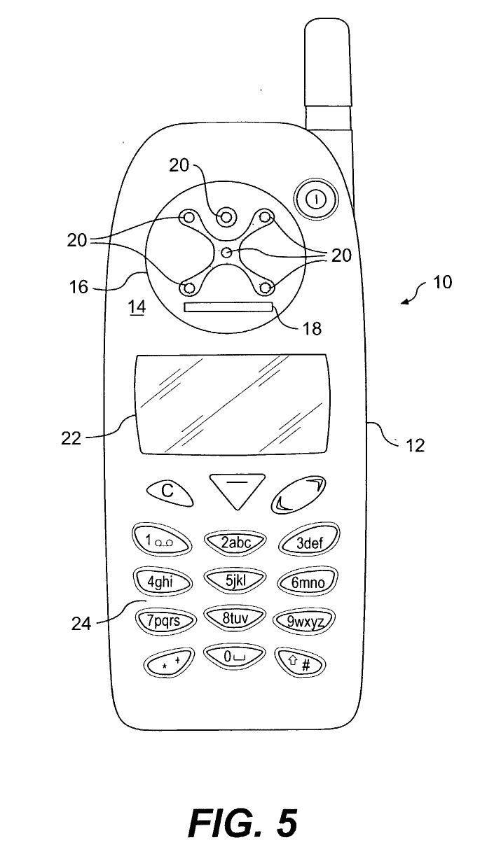

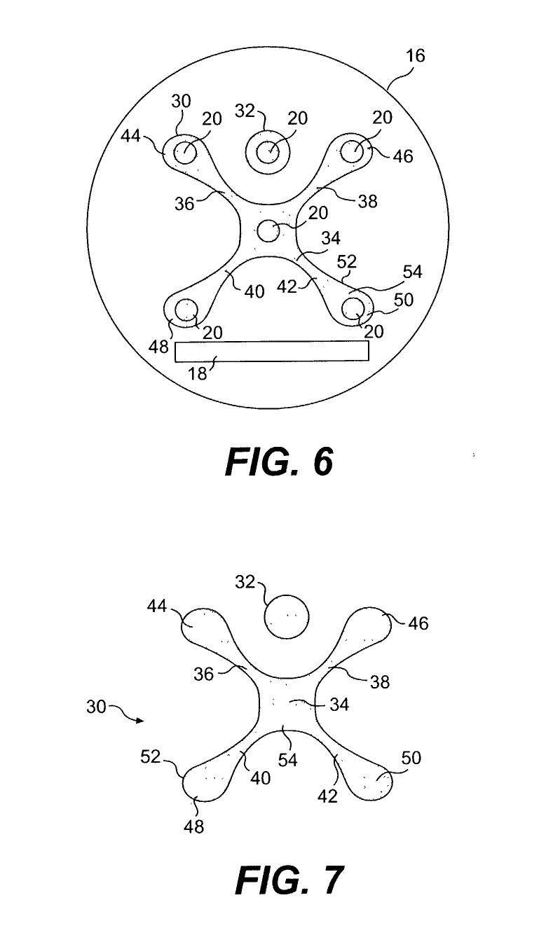

As shown in FIGS. 5 and 6, in another embodiment, the wireless device 10 includes a single opening 18 that generally has a thin rectangular shape and the logo 30 for the speaker area 16 is provided by using a plurality of false holes 20 positioned proximal to the opening 18, and may also include stenciling, embossing, silk screening, coloring, painting, indenting, texturing, applying a sticker, or a combination of any of the foregoing. Again, while the opening 18 is shown as being rectangular in shape, it should be appreciated that the opening 18 may comprise a variety of shapes. For this embodiment, it is preferred that the opening 18 be rectangular in shape so that the logo 30 seems to be standing on the opening 18. The logo 30 provided in the speaker area 16 shown in FIGS. 5 and 6 may be formed in a manner such as described above with respect to the embodiment shown in FIGS. 3 and 4.

Accordingly, the present invention allows a company to place its logo, name, or trademark in the speaker area of a wireless device, an area where the end user often looks. This provides increased brand impact on at least the end user, as well as the general public. In one embodiment, the logo, name, or trademark is provided, at least in part, by using at least one speaker opening. However, the logo, name, or trademark may be provided without using a speaker opening and may instead be positioned around or above one or more speaker openings. In one embodiment, the logo, name, or trademark is provided, at least in part, by using at least one false hole. Using the false holes as guides to avoid affecting the sound quality from the speaker opening(s), a logo, name, or trademark may be provided in the speaker area around the false holes by, for example, stenciling, embossing, silk screening, coloring, painting, texturing, indenting, applying a sticker thereto, or a combination of any of the foregoing.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of branding a wireless device, wherein the wireless device includes a housing having at least a first wall, wherein the first wall includes a speaker area, the method comprising the step of providing a logo in a design of the speaker area.

2. The method of branding a wireless device of claim 1, wherein the logo is provided in the speaker area using at least one of one or more openings defined in the first wall through which sound travels from a speaker provided within the housing of the device; one or more false holes provided on the first wall; or stenciling, embossing, silk screening, coloring, painting, texturing, indenting, or applying a sticker to the first wall.

3. The method of branding a wireless device of claim 2, wherein at least one of the one or more openings defined in the first wall is a guide for stenciling, embossing, silk screening, coloring, painting, texturing, indenting, or applying a sticker to the first wall to provide the logo.

4. The method of branding a wireless device of claim 2, wherein at least one of the one or more false holes provided on the first wall is a guide for stenciling, embossing, silk screening, coloring, painting, texturing, indenting, or applying a sticker to the first wall to provide the logo.

5. The method of branding a wireless device of claim 2, wherein at least one of the one or more false holes provided on the first wall and at least one of the one or more false holes are guides for stenciling, embossing, silk screening, coloring, painting, texturing, indenting, or applying a sticker to the first wall to provide the logo.

6. The method of branding a wireless device of claim 1, wherein the logo is provided in the speaker area using a plurality of one or more openings defined in the first wall through which sound travels from a speaker provided within the housing of the device; one or more false holes provided on the first wall; stenciling, embossing, silk screening, coloring, painting, texturing, indenting, or applying a sticker to the first wall; or a combination of any of the foregoing.

7. The method of branding a wireless device of claim 6, wherein at least one of the one or more openings defined in the first wall is a guide for stenciling, embossing, silk screening, coloring, painting, texturing, indenting, applying a sticker to the first wall, or a combination of any of the foregoing, to provide the logo.

8. The method of branding a wireless device of claim 6, wherein at least one of the one or more false holes provided on the first wall is a guide for stenciling, embossing, silk screening, coloring, painting, texturing, indenting, or applying a sticker to the first wall, or a combination of any of the foregoing, to provide the logo.

9. The method of branding a wireless device of claim 6, wherein at least one of the one or more false holes provided on the first wall and at least one of the one or more false holes are guides for stenciling, embossing, silk screening, coloring, painting, texturing, indenting, or applying a sticker to the first wall, or a combination of any of the foregoing, to provide the logo.

10. The method of branding a wireless device of claim 1, wherein the logo is at least one of a wireless carrier or a manufacturer of the wireless device.

11. The method of branding a wireless device of claim 1, wherein the logo is at least one of a company name, logo, or trademark.

12. The method of branding a wireless device of claim 1, wherein the speaker area is provided for a speaker that provides voice conversations.

13. The method of branding a wireless device of claim 1, wherein the speaker area is provided for a speaker that provides tones.

14. A wireless device comprising a housing having at least a first wall, wherein the first wall includes a speaker area, and wherein a logo is provided in a design of the speaker area.

15. The wireless device of claim 14, wherein the logo is provided in the speaker area using at least one of one of one or more openings defined in the first wall through which sound travels from a speaker provided within the housing of the device, one or more false holes, stenciling, embossing, silk screening, coloring, painting, texturing, indenting, or applying a sticker.

16. The wireless device of claim 15, wherein at least one of the one or more openings defined in the first wall is a guide for stenciling, embossing, silk screening, coloring, painting, texturing, indenting, or applying a sticker to the first wall to provide the logo.

17. The wireless device of claim 15, wherein at least one of the one or more false holes provided on the first wall is a guide for stenciling, embossing, silk screening, coloring, painting, texturing, indenting, or applying a sticker to the first wall to provide the logo.

18. The wireless device of claim 15, wherein at least one of the one or more false holes provided on the first wall and at least one of the one or more false holes are guides for stenciling, embossing, silk screening, coloring, painting, texturing, indenting, or applying a sticker to the first wall to provide the logo.

19. The wireless device of claim 14, wherein the logo is provided in the speaker area using a plurality of one or more openings defined in the first wall through which sound travels from a speaker provided within the housing of the device, one or more false holes, stenciling, embossing, silk screening, coloring, painting, texturing, indenting, applying a sticker, or a combination of any of the foregoing.

20. The wireless device of claim 19, wherein at least one of the one or more openings defined in the first wall is a guide for stenciling, embossing, silk screening, coloring, painting, texturing, indenting, applying a sticker to the first wall, or a combination of any of the foregoing, to provide the logo.

21. The wireless device of claim 19, wherein at least one of the one or more false holes provided on the first wall is a guide for stenciling, embossing, silk screening, coloring, painting, texturing, indenting, or applying a sticker to the first wall, or a combination of any of the foregoing, to provide the logo.

22. The wireless device of claim 19, wherein at least one of the one or more false holes provided on the first wall and at least one of the one or more false holes are guides for stenciling, embossing, silk screening, coloring, painting, texturing, indenting, or applying a sticker to the first wall, or a combination of any of the foregoing, to provide the logo.

23. The wireless device of claim 14, wherein the logo is at least one of a wireless carrier or a manufacturer of the wireless device.

24. The wireless device of claim 14, wherein the logo is at least one of a company name, logo, or trademark.

25. The wireless device of claim 14, wherein the speaker area is provided for a speaker that provides voice conversations.

26. The wireless device of claim 14, wherein the speaker area is provided for a speaker that provides tones.
